(19) United States
(12) Patent Application Publication
(10) Pub. No.: US 2005/0238078 A1
(43) Pub. Date: Oct. 27, 2005

(54) Optical resonator produced by optical contacting to join optical elements and use thereof, for example, for chemical and biochemical detection in liquids

(76) Inventor: Andrew C.R. Pipino, Gaithersburg, MD (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/829,963

(22) Filed: Apr. 23, 2004

(51) Int. Cl. H01S 3/08

(52) U.S. Cl. 372/92

(57) ABSTRACT

A new class of optical resonators fabricated by precision optical contacting is described. The new resonators are useful, for example, for chemical and biochemical detection in liquids in which the optical resonator is the sensing element. Novel resonator designs can be achieved by contacting multiple components to form integral optical resonators with low-loss, mechanically strong bonds between components.

A new class of optical resonators fabricated by precision optical contacting is described. The new optical resonators are useful, for example, for chemical and biochemical detection in liquids in which the optical resonator is the sensing element. Novel resonator designs can be achieved by contacting multiple components to form integral optical resonators with low-loss, mechanically strong bonds between components. High-reflectivity coatings, low-bulk-loss optical materials, and low-scatter-loss total-internal-reflection (TIR) surfaces can be used to further minimize the total optical loss. TIR surfaces also can provide an evanescent wave to sample optical properties such as absorption, emission, scattering, or refractive index of material in the area to which the wave extends. For instance, the properties of an ambient liquid, film, or adsorbed material in such area can be determined. Stigmatic, weakly astigmatic, and astigmatic Gaussian mode resonators and whispering gallery mode resonators are possible designs that can be achieved and used as the sensing element in chemical and biochemical sensors immersible in a liquid sample. In particular, immersible sensors with little or no astigmatism, which are fabricated from low-refractive-index optical materials such as fused silica, are examples. Further, resonators are described with vicinal input and output ports, which facilitate the construction of compact, distal probes where input and output beams are introduced and accessed in spatial proximity. In at least one embodiment, multiple input and output ports may be employed in parallel in a single device such that multiple spectral regions can be probed simultaneously. In other embodiments, an arbitrary angle of incidence at the TIR surfaces is permitted, thereby allowing an optimum selection of incident angle. Chemical species of interest can be detected in a bulk liquid or adsorbed from solution onto a TIR surface. When adsorption is employed, the resonator surface can be modified to selectively enhance adsorption of the analyte.

Chemical sensing in liquid media is fundamental in medical diagnostics, industrial process control, water quality assurance, and national security. In recent years, resonator-enhanced optical sensing techniques have shown promise in a range of applications, providing substantial gains in sensitivity with minimal increase in measurement complexity. Yet extension of these techniques to chemical and biochemical detection in liquids is rudimentary. The invention disclosed herein provides a new class of resonators that, for example, enable enhanced chemical and biochemical sensing in liquid media with considerable generality and adaptability. The invention circumvents limitations of existing technologies to address medical, industrial, national, and global needs.

### BACKGROUND OF THE INVENTION

To be effective, a chemical sensing technology must provide sufficient sensitivity and selectivity. Yet other physical parameters such as stability, robustness, size, and geometry, often determine the ultimate success or failure of a sensing technology. In particular, small, immersible, distal probe designs with vicinal input and output ports are highly desirable, providing adaptable, point-wise sampling of the environment of interest, while signal detection and processing occur at a relatively remote location. Although many transduction mechanisms exist for chemical sensing, optical methods in particular are widely used. In general, optical methods encompass all variations of absorption, emission, scattering of electromagnetic radiation, whether coherent or incoherent. In recent years, the detection sensitivity of optical methods has been significantly enhanced through the use of stable optical resonators; see, e.g., J. Ye et al., J. Opt. Soc. Am., B 15, 6, (1998), M. D. Wheeler et al., J. Chem. Soc. Faraday T., 94; (3), 337, (1998); G. Berden et al., Int. Rev. Phys. Chem., 19 (4), 565 (2000); and K. W. Busch et al., eds., Cavity-Ringdown Spectroscopy (Oxford U. Press, New York, 1999). By definition, a stable optical resonator (A. E. Siegman, Lasers, (University Science Books, 1986)) supports recirculating, self-replicating optical modes, which can be employed to provide long effective paths lengths through a sample medium, thereby enhancing sensitivity. In particular, low loss optical resonators typically provide greater sensitivity enhancement because the injected optical energy experiences a larger number of circulations, or equivalently, circulates for a longer time, before the intensity decays below detection threshold. Available low-loss optical coatings, optical materials, and polishing techniques permit resonators with round-trip losses of <0.1% to be readily constructed, providing 10³ or more circulations.

While the vast majority of optical-resonator-enhanced measurements have been applied to gas phase spectroscopy, a few applications to liquids have recently appeared. Common linear optical resonators, which are discussed in detail elsewhere (A. E. Siegman, Lasers, (University Science Books. 1986)) have been adapted to liquid diagnostics (see, e.g., A. J. Hallock et al. Anal. Chem., 74 (7), 1741, (2002); and S. C. Xu et al., Rev. Sci. Instrum., 73 (2), 255, (2002). Hallock et al. employed a linear resonator in which the resonator mirrors formed integral windows to the liquid cell. Xu et al. used a compensating pair of conventional cuvettes at Brewster's angle inside a linear resonator to contain solutions. Although the methods used by Hallock et al. and by Xu et al. demonstrated good detection sensitivity for liquids, these methods employed resonator configurations that are not readily or optimally adapted to a miniature, distal probe. Furthermore, the intra-cavity cuvettes used by Xu et al. introduced superfluous losses, which degraded the ultimate sensitivity of the measurement. In addition, linear resonators are not well-suited to biochemical detection, which optimally employs an evanescent wave to probe a molecular binding event in a monolayer. Fiber resonators have been employed for the measurement of optical properties of liquids (see, e.g., T. von Lerber et al., Opt. 41(18), 3567, (2002); and M. Gupta et al., Opt. Lett. 27 (21), 1878, (2002)) by accessing the concomitant evanescent wave in a cladding-free region. Von Lerber et al. monitored the cladding etching process in solution by employing a resonator formed by coating polished ends of an optical fiber with a high reflectivity coating. However, the imperfections associated with polishing and coating the fiber terminus introduced superfluous losses, resulting in loss of detection sensitivity in comparison to predictions based on established coating and fiber properties. To circumvent these limitations, Manish et al. (Opt. Lett. 27 (21), 1878, (2002)) employed fiber Bragg gratings as reflectors. Although the Bragg gratings introduce a relatively large loss, a change in refractive index of an ambient liquid was detected with the evanescent wave. In the work of Pipino (Phys. Rev. Lett. 83 (15), 3093-3096, (1999); U.S. Pat. No. 5,835,231; Appl. Opt. 39 (9), 1449 (2000); U.S. Pat. No. 5,986,768, an evanescent wave was also used for chemical detection by employing a broadband, total-internal-reflection (TIR)-ring resonator or a narrow bandwidth monolithic, folded resonator. Although in principal the TIR-ring resonator can form an immersible, distal probe for liquids, this design only permits a discrete set of incident angles based on a regular polygonal geometry. Furthermore, the TIR-ring design requires the use of photon tunneling for input and output coupling, which complicates the construction of a robust probe. In addition, the steep angle of incidence at the TIR surface that is required for sampling bulk liquids with an immersible, low-refractive index optical probe, results in highly astigmatic modes. Similarly, the monolithic, folded resonator also suffers from severe astigmatism at steep incident angles. In addition, the input and output beam directions are highly disparate for steep incident angles, which complicates or prohibits probe design, especially when the resonator material has a low refractive index such as that of fused silica. The whispering gallery modes (WGM's) of microspheres have also been used to probe liquids (see, e.g., J. L. Nadeau et al., “High-Q whispering-gallery mode sensor in liquids”, in Laser Resonators and Beam Control V, Alexis V. Kudryashov, Editor, Proceedings of SPIE, Vol. 4629, 172, (2002). Although the use of microspheres in a single-ended probe design appears promising, currently available microsphere fabrication strategies provide limited control of surface roughness and material purity. The effective angle of incidence of a WGM is also invariant whereas an ability to optimize the angle of incidence for given index discontinuity is preferred to achieve maximum sensitivity and adaptability. While each approach discussed above has merits within a given domain of application, the challenge of achieving an immersible, resonator-enhanced, distal optical probe for chemical and biochemical detection in liquids has remained. Furthermore, optical contacting has never been employed to fabricate optical resonators for the purpose of chemical or biochemical sensing.

Although the technique of optical contacting has been used for many years, innovative forms continue to appear (see for example U.S. Pat. Nos. 5,669,997 and 6,284,085). In essence, the technique involves the formation of a single solid by contacting two or more solids, usually with identical composition, under conditions involving elevated temperature, elevated pressure, or controlled surface chemistry. Ideally, the interface between the solids is indistinguishable from the bulk material in all directions. Therefore, the interface, to the extent it remains at all, becomes optically transparent, having little or no associated Fresnel reflection loss. The invention disclosed herein exploits this capability to fabricate novel optical resonators that form the sensing element of a chemical or biochemical detection system.

### SUMMARY OF THE INVENTION

A class of optical sensors is provided in which the sensing element is a low-loss optical resonator that requires or benefits from precision optical contacting in the fabrication process. Novel resonator designs are realized by contacting multiple components to form integral sensing elements with low-loss, mechanically strong bonds between components. For example, stigmatic, weakly astigmatic, and astigmatic Gaussian mode resonators and WGM resonators are described. The optical resonators are useful for chemical and biochemical detection, particularly in liquids. They can be immersed in a liquid to detect chemical species through a change in optical properties. In particular, immersible sensors with little or no astigmatism can be fabricated from low refractive index optical materials. Further, resonator designs are described with vicinal input and output ports to facilitate construction of single-ended probes. Multiple, pairs of input/output ports can also be employed to permit multiple spectral regions to be probed simultaneously by a single device. High-reflectivity coated surfaces are employed to permit direct excitation of resonator modes by a propagating optical beam, while TIR surfaces provide an evanescent wave for sampling the optical properties of the ambient medium. Some embodiments further provide for an arbitrary angle of incidence at the TIR surface. Chemical species of interest can be detected in a bulk liquid or adsorbed to the TIR surface. The latter detection scheme is particularly applicable to bio-sensing. In the case of bulk liquids, the sensor can be immersed in the liquid. Further, the current invention can be employed directly to probe refractive index by exploiting the sensitivity of the resonator finesse to propagation losses at a TIR surface when the incident angle approaches the critical angle.

Thus, the description herein includes optical resonators comprising at least two optical elements of high-quality, low-loss optical material that are joined together primarily by optical contacting to provide an optical resonator having internal reflection surfaces. To provide resonator stability, at least one convex surface exists, which can be a high reflectivity coated surface or a TIR surface. The resonator supports re-circulating and self-replicating optical modes within the resonator. In one embodiment, the optical resonator has at least one total internal reflection surface that emanates at least one evanescent wave external to the resonator when light is introduced. In this embodiment, an apparatus for sensing of at least one chemical or biochemical material in a sample can be provided. The apparatus has the optical resonator as sensing element, a means for providing a sample to be sensed external to the resonator in a location where the at least one evanescent wave emanates, a means for providing light for injection into the resonator, and a means for evaluating the light exiting the resonator to determine at least one optical property of the sample wherefrom the presence of the at least one chemical or biochemical material is sensed. This apparatus can be used, for example, to sense chemical or biochemical material in a liquid or material adsorbed onto the surface of resonator from which the at least one evanescent wave emanates. In the surface adsorption embodiment, the external surface of the resonator from which at least one evanescent wave emanates has a surface which selectively adsorbs specific chemical or biochemical material(s) and these adsorbed material(s) are sensed. See, e.g., Pipino U.S. Pat. No. 6,515,749, incorporated herein by reference, disclosing a nanostructured surface which can be used for this purpose.

The evanescent wave can be used to measure optical-properties, for example, absorption, of a sample in the way generally discussed in U.S. Pat. No. 5,986,768, which discussion is incorporated herein by reference. Thus, total reflection in the resonator generates an evanescent wave that decays exponentially in space at a point external to a total internal reflection surface, thereby providing a localized region where absorbing materials can be sensitively probed through alteration of the Q-factor of the otherwise-isolated resonator. When a light pulse is injected into the resonator and passes through the evanescent state, an amplitude loss resulting from absorption is incurred that reduces the lifetime of the pulse in the resonator. By monitoring the decay of the injected pulse, the absorption coefficient of matter within the evanescent wave region, is accurately obtained from the decay time measurement. In some embodiments, microsampling with high-spatial resolution is achieved through repeated refocussing of the light pulse at the sampling point, under diffraction-limited conditions.

Advantageously, the measuring means comprises a photomultiplier tube or other sensitive photodetector. In a preferred embodiment, the means for introducing light and the means for measuring the exiting light are optically coupled to the resonator with fiber-optic waveguides. The means for introducing light preferably comprises a laser and more preferably comprises a pulsed or a continuous wave laser. In another preferred embodiment, the laser comprises a diode laser.

The invention is also directed to methods of preparing an optical resonator as described above which comprises joining at least two optical elements of high-quality, low-loss optical material together, primarily by optical contacting. The high-quality, low-loss optical material used to form the resonator is preferably formed of fused silica. Each of the two or more components joined together by optical contacting to form the resonator are preferably of the same material but they can be of differing material if the differing materials allow an interface upon optical contacting which is optically transparent, having little or no associated Fresnel reflection loss. The optical contacting of the components can be achieved according to known methods. Typically, this involves providing the opposing surfaces of the components to be contacted such that there is a high extent of contact between them. This can be done, preferably, by superpolishing each of the surfaces to be contacted. The superpolishing can be by known methods, such as that described in N. J. Brown, Ann. Rev. Maier. Sci., 16, p. 371 (1986), incorporated herein by reference. Superpolishing is also useful to finish the non-contacting Surface of the optical components for high-reflectivity and low-loss. For example, mirrors with 99.99% reflectivity or better can be fabricated to construct low-loss optical cavities, thereby permitting ultra-high sensitivity to be routinely realized. The high contact surfaces are brought together, optionally under elevated temperature, elevated pressure, or using controlled surface chemistry, and the components bond together at the contacting surfaces. The optical contacting method can simply be carried out by bringing together the components to be joined along their contact surfaces. But other variations of optical contacting methods can be utilized. Preferably, the optical contacting is conducted under clean room conditions since ambient contaminants and environmental conditions, such as humidity, will affect the strength of the bond formed. Surface modification, for example, chemical modification, such as described in U.S. Pat. No. 6,284,085, incorporated herein by reference, can enhance the strength of the bond. Mechanical strengthening methods, such as described in U.S. Pat. No. 5,669,997, incorporated herein by reference, can also be used in conjunction with the optical contacting. But the primary connection of components is through optical contacting.

The two or more optical components are joined to make an optical resonator having internal reflection surfaces and at least one curved, convex reflection surface which can be a TIR surface or a high-reflectivity coated surface, whereby the resonator supports introduction of light into the resonator, recirculating and self-replicating optical modes within the resonator and the exit of light from the resonator. The use of optical contacting to join differing components allows for the production of resonator designs which would be difficult or impossible to produce as a single piece. The design of the optical resonator can be of known design but prepared by optical contacting of components or can be a new design made possible or practical due to the use of the optical contacting method. Useful designs include optical resonators:
wherein the resonator supports introduction of light into the resonator at an entrance axis and exit of light from the resonator at an exit axis proximate to the entrance axis and parallel to the entrance axis but in the opposite direction.
which is a twin-stemmed stigmatic resonator having at least one optical element which is a stem having a highly reflective coated convex surface for introduction of light at normal incidence, at least one optical element which is a parallel stem having a highly reflective coated convex surface for exit of light parallel to the introduced light but in the opposite direction and an optical element which is a resonating chamber for resonating the introduced light and producing the exiting light, whereby the optical element stems are joined to the optical element resonating chamber primarily by optical contacting; in a further embodiment, this type of resonator may have two or more pairs of the stems for the introducing and exiting of light and a single optical element resonating chamber for all of the stem pairs to enable, for example, multiple laser sources having different wavelengths to operate Simultaneously.
which is an astigmatic: variable angle, retro-reflecting resonator comprising two or more optical elements joined primarily by optical contacting, a highly reflective coated surface for introduction of light and exit of light parallel to the introduction but in the opposite direction and opposing highly reflective total internal reflection curved, convex surfaces.
which is a polygonal, astigmatic, retro-reflecting resonator comprising two or more optical elements joined primarily by optical contacting, a highly reflective coated surface for introduction of light and exit of light parallel to the introduction but in the opposite direction, a polygonal resonating chamber with multiple highly reflective coated surfaces, at least one highly reflective total internal reflection surface being a curved, convex surface.
which is a weakly astigmatic, variable-angle resonator comprising two or more optical elements joined primarily by optical contacting, an adjacent pair of highly reflective coated surfaces angled to each other for, respectively, introduction of light and exit of light at an angle from the introduced light, a distally extending resonating chamber with opposing multiple total internal reflection surfaces and a highly reflective coated surface being a curved, convex surface at the distal end of the chamber.
which is a hemispherical retro-reflecting resonator comprising two or more optical elements joined primarily by optical contacting, a highly reflective coated surface for introduction of light and exit of light parallel to the introduction but in the opposite direction and a hemispherical resonating chamber having a highly reflective coated surface, whereby the introduced light excites one or more whispering gallery modes of the hemisphere confined by total internal reflection along the perimeter of the hemisphere.

In another embodiment, it is desirable to have an optical resonator which is in the form of a distal probe or forms the distal end of a distal probe, preferably of a small diameter, e.g., from 0.1 millimeter to 3 centimeters. Each of the above-discussed designs, for example, can be used for such a distal probe.

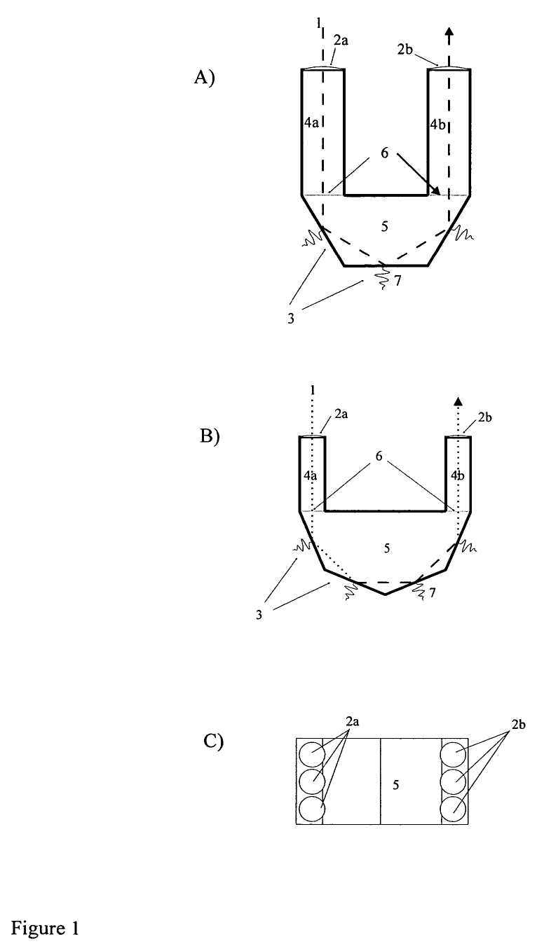

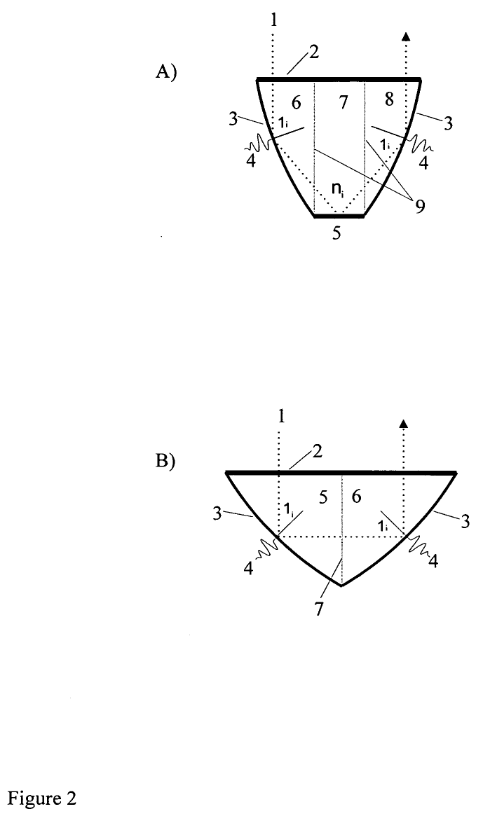

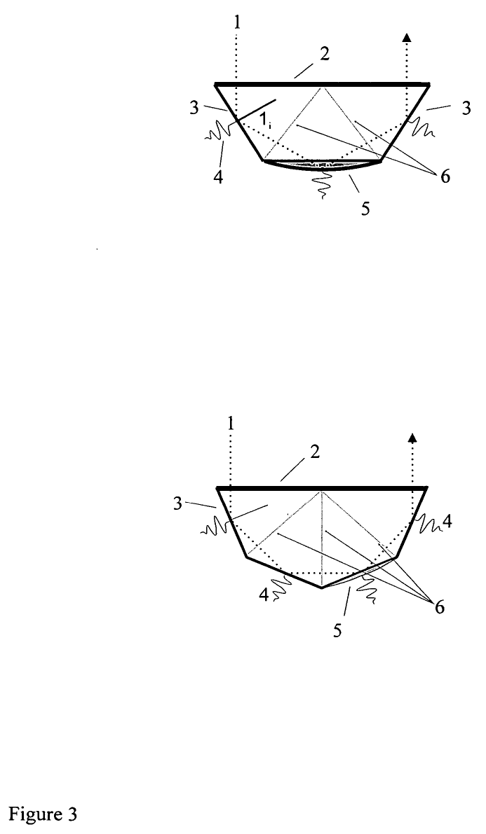

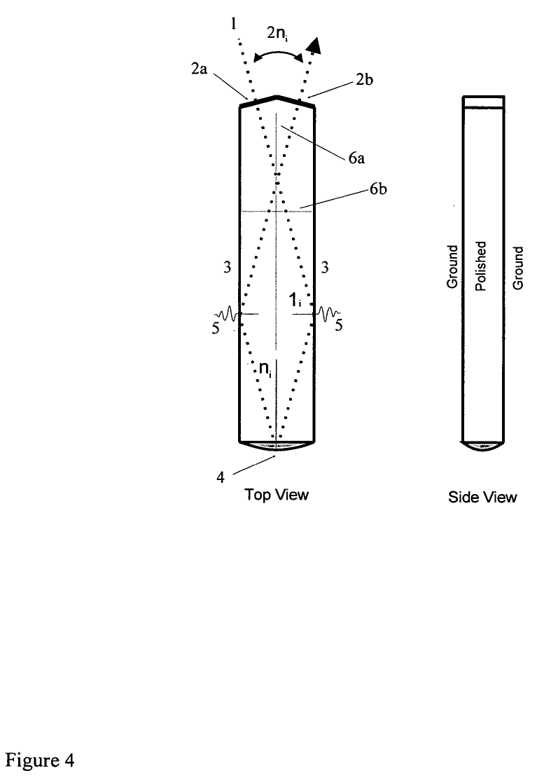

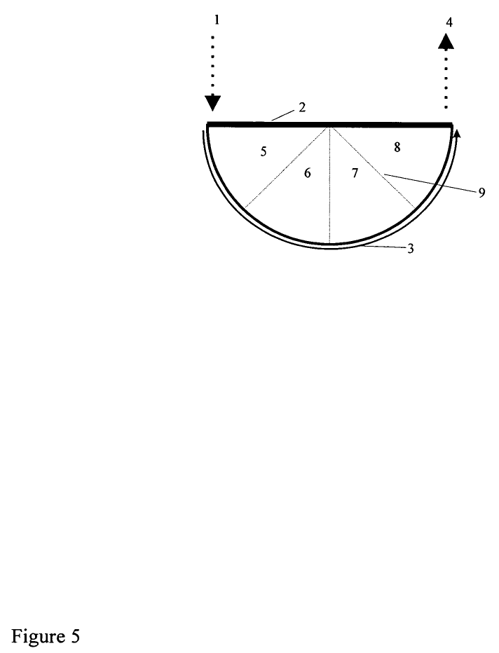

Five specific, non-limiting realizations of the invention, which are chosen to demonstrate specific characteristics, are shown in FIGS. 1 through 5. In FIG. 1, a twin-stemmed, stigmatic resonator (TSSR) is shown. The TSSR design provides a discrete range of incidence angles at the TIR surfaces with multiple TIR reflections, utilizes vicinal, symmetrical input and output ports, and incurs no astigmatism. Multiple ports can be employed to effectively create a broadband device. FIG. 2 shows an astigmatic, variable angle, retro-reflecting resonator (AVARR). The AVARR design permits an arbitrary incident angle at a symmetrical pair of TIR surfaces with a high degree of astigmatism. The symmetrical, retro-reflecting, ‘nose-cone’ design can be beneficial in probe construction. In FIG. 3, the polygonal, astigmatic, retro-reflecting resonator (PARR) is shown. The PARR design provides a discrete set of incident angles, multiple sampling points, and direct excitation of resonator modes by a propagating wave. For steep angles of incidence, this design is highly astigmatic. In FIG. 4, a weakly astigmatic, variable angle resonator (WAVAR) is shown. The WAVAR design provides for any arbitrary angle of incidence at the two, symmetrically located TIR surfaces, and incurs only weak astigmatism. The linear geometry with vicinal input and output facets readily permits the construction of a single-ended probe. In FIG. 5, a hemispherical retro-reflecting resonator (HSRR) is shown, which is fabricated from ‘orange slice’—like elements. The equatorial plane of the resonator is a high-reflectivity coated surface. The HSRR supports whispering gallery modes that are well known for a sphere, but excitation can be accomplished more easily for the HSRR by a propagating wave that is normally incident on the high reflectivity coated surface. More detailed descriptions of the drawings for these designs are given below. Other designs can be conceived based on variations of these principles.

Two examples of twin-stemmed, stigmatic resonators (TSSR) for chemical detection in liquids are shown in FIG. 1. A discrete set of incident angles is allowed, given by Θᵢ(N)=π/2(1−1/N), where N is the number of total-internal reflections occurring per pass. For the examples shown, A) Θᵢ(3)=60° and B) Θᵢ(4)=67.5°. A light beam (1) is injected at normal incidence into the resonator at the high-reflectivity-coated, convex surface (2a) and exits at high-reflectivity-coated, convex surface (2b). The excited cavity modes experience N total-internal reflections at surfaces (3) per pass through the resonator, such that the transmitted beam at (2b) is reversed in direction, relative to the incident beam at (2a). Because the circulating cavity modes are normally incident on the convex surfaces, they posses at most primitive astigmatism (image reversal for an odd number of reflections). The modes are similar to those of a symmetric, linear resonator with an additional polarization dependent phase shift incurred at the planar TIR surfaces. The resonator can be assembled by optical contacting of elements (4a), (5), and (4b), along low-loss seams (6), although another choice could be employed. Elements (4a) and (4b) can be identical, simplifying fabrication and leading to a resonator mode waist at the midpoint of the cavity. Additionally, because the resonator optic axis is defined by the centers of curvature for the two convex surfaces of the stems, multiple pairs of stems, such as (4a) and (4b) may be contacted onto a single base (5), permitting multiple wavelengths to be sampled simultaneously. A multi-stem example is depicted in FIG. 1C, where a top-view perspective is given for the resonator in (B). In this particular embodiment, three input (2a) and three output (2b) ports are employed on the same base (5). In this case, each pair of input and output ports can be coated with a high-reflectivity coating for a different wavelength range, thereby providing a device that, for example, can detect multiple species or the same species at multiple wavelengths. Furthermore, the two convex surfaces, (2a) and (2b), can be replaced by a single convex surface and second planar surface, in which case the resonator mode waist is located at the planar, high-reflectivity-coated surface. The portion of stem elements (4a) and (4b) extending beyond element (5) can be cylindrical with respect to the optic axis, facilitating external connections. The evanescent waves (7) at the TIR surfaces (3) probe the ambient liquid.

FIG. 2A shows an astigmatic, variable angle, retro-reflecting resonator (AVARR), while FIG. 2B shows a 45°-incident-angle variant of this design. A light beam (1) enters and exits the resonator through high-reflectivity coated surface (2). The excited cavity modes undergo TIR at the two, typically identical, spherical surfaces (3), which do not possess the same center of culvature. The evanescent waves (4) probe the ambient medium. The angle of incidence, Θᵢ, at the TIR surfaces can be optimally chosen. An intermediate reflection at high-reflectivity-coated surface (5) in (A) at angle of incidence, φᵢ, is then determined such that the sum of all incident angles inside the resonator equals π to achieve the retro-reflection condition. In (B), the retro-reflection condition is achieved without the use of an intermediate reflection. The variable angle of incidence at the TIR surface permits an optimal value to be chosen, for example, to optimize sensitivity. A steep angle of incidence can be employed for a resonator of design (A) to permit dense liquids or thick sensing films to be probed, even for a low refractive index resonator material. Resonators (2A) and (2B) can be fabricated by optical contacting along one or more seams. In (A), low-loss seams (9) bond components (6), (7), and (8), while in (B), low-loss seam (7) bonds components (5) and (6), although other variations are possible.

The polygonal, astigmatic, retro-reflecting resonator (PARR) is shown in FIG. 3. The discrete set of incident angles, Θᵢ(N), and the number of TIR reflections per pass, N, are related by Θᵢ(N)=π/2(1−1/N), where for A) Θᵢ(3)=60° and B) Θᵢ(4)=67.5°. A light beam (1) enters and exits the resonator through high-reflectivity coated surface (2). After N intra-cavity TIR reflections at surfaces (3), which provide evanescent waves (4), the output beam is retro-reflected in comparison to the input beam. A spherical, TIR surface (5) imparts stability to the circulating resonator modes. For steep angles of incidence, this design is highly astigmatic, although liquids can be probed with a low refractive index resonator, for sufficiently large N. The PARR design can be achieved by contacting multiple, essentially identical components along seams (6), where a convex surface (7) must be present on one of the components.

A weakly astigmatic, variable angle resonator (WAVAR) is shown in FIG. 4. A light beam (1) enters and exits the resonator at adjacent high-reflectivity-coated planar surfaces, (2a) and (2b), respectively, whose surface normals are separated by a modest or small angle of 2φᵢ. The resonator modes undergo TIR at surfaces (3) at a typically steep angle of incidence given by Θᵢ=π/2−φ, which is optimally chosen, based on the application. A spherical, high-reflectivity-coated surface (4) provides stability for the resonator modes, while imparting only weak astigmatism due to the shallow angle of incidence of φᵢ. The complementary steep angle of incidence at the TIR planar surfaces permits dense liquids or a thick sensing layer to be probed by the concomitant evanescent wave (5). A low refractive index optical material such as fused silica may be employed for fabrication without introducing prohibitive propagation losses or astigmatism. Optical contacting at seams (6a) or (6b) or otherwise could be employed to simplify the fabrication process.

FIG. 5 shows a hemispherical retro-reflecting resonator (HSRR). The input beam (1) enters the resonator at high-reflectivity coated surface (2), where it excites one or more whispering gallery modes (WGM's) of the hemisphere, which are confined by TIR along the perimeter of the hemisphere. The evanescent wave (3) emanates from the perimeter to permit the optical properties of an ambient medium to be probed. The output (4) of the HSRR exits through the high reflectivity coated surface (2) in the retro-reflected direction. The HSRR can be fabricated by precision optical contacting of ‘orange slice’—like elements, such as (5) through (8), along low-loss seams such as (9). An optical waveguide could also be optically contacted to coated surface (2) to facilitate WGM excitation and to form a rugged, distal probe.

As discussed above, the optical resonators of the invention are useful, for example, as the sensing element in methods for sensing at least one chemical or biochemical material in a sample. The methods comprise determining the optical properties of the sample by subjecting the sample to an evanescent wave emanating from an apparatus containing the optical resonator having a total internal reflection surface. The methods are particularly applicable to sensing chemicals or biological agents in liquid samples or on a material adsorbed onto the surface of the resonator from which the at least one evanescent wave emanates. In the adsorbed materials embodiment, a surface can be provided which selectively adsorbs specific chemical or biochemical material(s) which adsorbed material(s) are sensed. This embodiment is particularly useful for sensing biological agents where a surface is provided for specific adsorption of particular biological agents.

The optical resonators are also useful in methods for measuring the refractive index of a bulk medium. Herein, the bulk medium is in contact with the optical resonator, which also has a light source and the loss occurring through the surface(s) of the optical resonator by propagation into the bulk medium is determined. The induced propagation loss is related to and very sensitive to changes in the refractive index of the ambient medium. In particular, slight refractive index changes arising from a band or slug of dissolved material could be detected as it passes by the evanescent wave region. This strategy could form a novel detector in chromatography or microfluidics.

Hence, the optical resonators can be used in methods for measuring the density of a material which moves along a surface the optical resonator from which an evanescent wave emanates, e.g., in a microchannel on the surface.

There is paucity of commercially available, single-ended, optical probes for chemical detection in liquids. Commercial biosensors are based on surface plasmon resonance (SPR), which detects refractive index or film thickness changes associated with chemical binding. Selectivity of SPR is determined by selective chemical interactions. The current invention can also employ SPR-based chemical detection through the teachings of U.S. patent application Ser. No. 924,576. However, the current invention can also employ direct absorption or total scattering as the optical observable. Further, the current invention can be employed directly to probe refractive index without SPR-enhancement by exploiting the sensitivity of the resonator finesse to propagation losses at a TIR surface when the incident angle approaches the critical angle. For example, direct sensing of refractive index can be applied to separation processes where passage of solute bands in a carrier fluid is detected. Current refractive index sensing methods, which are interferometry-based, provide routine detection of Δn≈10⁻⁵, with 10⁻⁶ possible under very stable conditions. The current invention can reach the 10⁻⁶ level with further improvements possible, while providing significant simplifications in the application and design of the measurement.

Particular applications of the methods for chemical/biochemical sensing include: biosensing; sensing water in organic liquids; sensing organic or biological compounds in water; sensing heavy metal ions and their solution phase complexes in liquid media; sensing chemical or biological warfare agents in liquid media: sensing other chemical species in either the liquid or vapor phase; and, use as a detector in chromatography or micro-fluidics.

1. An optical resonator comprising at least two optical elements of high-quality, low-loss optical material which elements are joined together primarily by optical contacting to provide an optical resonator having internal reflection surfaces, and at least one curved, convex reflection surface, whereby the resonator supports introduction of light into the resonator, recirculating and sell-replicating, optical modes within the resonator and the exit of light from the resonator.

2. The optical resonator of claim 1, wherein the resonator has at least one total internal reflection surface which emanates at least one evanescent wave external to the resonator when light is introduced.

3. An apparatus for sensing of at least one chemical or biochemical material in a sample which comprises an optical resonator of claim 2, capable of being placed in contact with a sample to be sensed such that at least one evanescent wave emanates into the sample, and a means for evaluating the light exiting the resonator to determine at least one optical property of the sample wherefrom the presence of the at least one chemical or biochemical material is sensed.

4. The apparatus of claim 3, wherein the sample is a liquid.

5. The apparatus of claim 3, wherein the sample is a material adsorbed onto the surface of resonator from which the at least one evanescent wave emanates.

6. The apparatus of claim 3, wherein the external surface of the resonator from which the at least one evanescent wave emanates is provided with a surface which selectively adsorbs specific chemical or biochemical material(s) which adsorbed material(s) are sensed.

7. The optical resonator of claim 1, wherein the resonator supports introduction of light into the resonator at an entrance axis and exit of light from the resonator at an exit axis proximate to the entrance axis and parallel to the entrance axis but in the opposite direction.

8. The optical resonator of claim 1, which is a twin-stemmed stigmatic resonator having at least one optical element which is a stem having a highly reflective coated convex surface for introduction of light at normal incidence, at least one optical element which is a parallel stem having a highly reflective coated convex surface for exit of light parallel to the introduced light but in the opposite direction and an optical element which is a resonating chamber for resonating the introduced light and producing the exiting light, whereby the optical element stems are joined to the optical element resonating chamber primarily by optical contacting.

9. The optical resonator of claim 8, which comprises two or more pairs of the stems for the introducing and exiting of light and a single optical element resonating chamber for all of the stem pairs.

10. The optical resonator of claim 1, which is an astigmatic, variable angle, retro-reflecting resonator comprising two or more optical elements joined primarily by optical contacting, a highly reflective coated surface for introduction of light and exit of light parallel to the introduced light but in the opposite direction and opposing highly reflective total internal reflection curved, convex surfaces.

11. The optical resonator of claim 1, which is a polygonal, astigmatic, retro-reflecting resonator comprising two or more optical elements joined primarily by optical contacting, a highly reflective coated surface for introduction of light and exit of light parallel to the introduced light but in the opposite direction, a polygonal resonating chamber with multiple total internal reflection surfaces, at least one total internal reflection surface being a curved, convex surface.

12. The optical resonator of claim 1, which is a weakly astigmatic, variable-angle resonator comprising two or more optical elements joined primarily by optical contacting, an adjacent pair of highly reflective coated surfaces angled to each other for, respectively, introduction of light and exit of light at an angle from the introduced light, a distally extending resonating chamber with multiple total internal reflective surfaces and a highly reflective coated surface being a curved, convex surface at the distal end of the chamber.

13. The optical resonator of claim 1, which is a hemi-spherical retro-reflecting resonator comprising two or more optical elements joined primarily by optical contacting, a highly reflective coated surface for introduction of light and exit of light parallel to the introduction but in the opposite direction and a hemispherical resonating chamber having a hemispherical total internal reflective surface, whereby the introduced light excites one or more whispering gallery modes of the hemisphere confined by total internal reflection along the perimeter of the hemisphere.

14. The optical resonator of claim 1, wherein the diameter of the resonator, at its largest, is from 0.1 millimeter to 3 centimeters.

15. A method for sensing at least one chemical or biochemical material in a sample which comprises determining an optical property of the sample by subjecting the sample to an evanescent wave emanating from an apparatus according to claim 3.

16. The method of claim 15, wherein the sample is a liquid.

17. The method of claim 15, wherein the sample is a material adsorbed onto the surface of resonator from which the at least one evanescent wave emanates.

18. The method of claim 15, wherein the external surface of the resonator from which the at least one evanescent wave emanates is provided with a surface which selectively adsorbs specific chemical or biochemical material(s) which adsorbed material(s) are sensed.

19. A method for measuring the refractive index of a bulk medium which comprises contacting the bulk medium with an optical resonator according to claim 1, providing a light source to the optical resonator and determining the loss occurring through the surface(s) of the optical resonator by propagation into the bulk medium.

20. A method for measuring the density of a material which comprises contacting the material with an optical resonator according to claim 1 which is provided a light source, such that the material flows in a channel along an external surface of the resonator from which an evanescent wave emanates so that the flow of material is sensed from which a density determination is made.

21. A method of preparing an optical resonator which comprises joining at least two optical elements of high-quality, low-loss optical material together primarily by optical contacting to provide an optical resonator having internal reflection surfaces, and at least one curved, convex reflection surface, whereby the resulting optical resonator supports introduction of light into the resonator, recirculating and self-replicating optical modes within the resonator and the exit of light from the resonator
